(19) United States
(12) Patent Application Publication
(10) Pub. No.: US 2007/0073973 A1
(43) Pub. Date: Mar. 29, 2007

(54) Method and apparatus for managing buffers in a data processing system

(75) Inventor: Alon Hazay, Tel Aviv (IL)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/238,562

(22) Filed: Sep. 29, 2005

(51) Int. Cl. G06F 13/00

(52) U.S. Cl. 711/133

(57) ABSTRACT

A buffer management for a data processing system is provided. According to one embodiment, a method for managing buffers in a telephony device is provided. The method comprising providing a plurality of buffers stored in a memory, providing a cache having a pointer pointing to the buffer, scanning the cache to determine if the cache is full, and when the scan determines the cache is not full determining a free buffer from the plurality of buffers, generating a pointer for the free buffer, and placing the generated pointer into the cache.

### FIELD OF THE INVENTION

The present invention relates to a method and apparatus for managing buffers in a data processing system, and more particularly, to a method and apparatus for managing free and busy buffers in a redundant software system.

### BACKGROUND

Buffer methods are commonly used in software to manage free and occupied buffers. In some cases the software uses language specific calls to manage the buffers. For example, in C++a “new” may be used to dynamically allocate a buffer and a “delete” may be used to dynamically release the buffer. In another method, a fixed number of buffers are created at an application startup, typically in an array, along with a management data table. The management data table manages the buffers via pointers to the pointers and a link list scheme to provide a link of which buffers are available for allocation. Commonly a Last In First Out (LIFO) link list is maintained by the management data table.

There exists a need to provide an improved way to manage and store buffers in a data processing system, e.g. computer or telephony device.

### SUMMARY OF THE INVENTION

In one aspect of the present invention, a method for managing buffers in a telephony device is provided. The method comprising providing a plurality of buffers stored in a memory, providing a cache having a pointer pointing to the buffer, scanning the cache to determine if the cache is full, and when the scan determines the cache is not full determining a free buffer from the plurality of buffers, generating a pointer for the free buffer, and placing the generated pointer into the cache.

In another aspect of the present invention, a device for managing memory is provided. The device comprising a data table stored in a first memory, a cache stored in a third memory and a scanner that scans the cache after a period of time. The data table having a used or a busy disposition of a buffer pool in a second memory. The buffer pool having a plurality of buffers. The cache having a plurality of pointers that points to a portion of the plurality of buffer with the free disposition. A number of pointers in the cache is fewer than a number of buffers in the plurality of buffers.

In yet another aspect of the present invention, a device for managing memory is provided. The device comprising a bit vector, a cache, and a scanner. The bit vector has a used or a busy disposition of a buffer in a buffer pool. The bit vector stored in a first memory and the buffer pool has a plurality of buffers stored in a second memory. The cache has a plurality of pointers pointing to a portion of the plurality of buffer with the free disposition. The cache has fewer pointers than buffers in the plurality of buffers. The scanner scans the cache and sets the disposition in the bit vector for a buffer in the plurality of buffers to busy, and adds to the cache a pointer pointing to the buffer.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates an exemplary prior art schematic diagram of a link list for managing buffers;

FIG. 2 illustrates an exemplary schematic diagram of managing buffers in accordance with the present invention;

FIG. 3 illustrates another exemplary schematic diagram of managing buffers in accordance with the present invention;

FIG. 4 illustrates another exemplary schematic diagram of managing buffers in accordance with the present invention;

FIG. 5 illustrates another exemplary schematic diagram of managing buffers in accordance with the present invention; and

FIG. 6 illustrates an exemplary schematic diagram of a hardware solution for managing buffers in accordance with the present invention.

### DETAILED DESCRIPTION OF THE INVENTION

The invention described herein may employ one or more of the following concepts. For example, one concept relates to a method of managing buffers in memory. Another concept relates to a cache having a fewer number of pointers than a number of buffers in a buffer pool. Another concept relates to avoiding starvation of the cache. Yet another concept relates to a reduced memory for buffer management.

The present invention is disclosed in context of a pointer being an index value, for example, and index into an array. The principles of this invention, however, are not limited to a pointer being an index value but may be applied a pointer having any suitable form of reference to a memory such as an address. The size of memory of the pointer is based on the type of pointer. Since the present invention is disclosed in context of the pointer being an index value, the memory sizes are calculated based on an index. Those skilled in the art would appreciate how the sizes are calculated. For example, a pointer based on an address for a 32-bit processor would have a 4-byte memory size. Additionally, while the present invention is disclosed in context of 65,536 buffers, it would be appreciated by those skilled in the art another number of buffers may be used. The present invention is disclosed in context of a data table in the format of a bit vector also known as a bit map. The bit vector advantageously has a smaller memory size than a pointer. However, the data table may have a data structure type other than a bit vector especially, for example, if it is desired to store more than the two values that a bit vector could store. Additionally, while the present invention is described in terms of a cache being a First In First Out (FIFO) list, it would be recognized by those skilled in the art that other data structures may be use such as a Last In First Out (LIFO) list. The principles of the present invention have particular application in a telephony device processing Ethernet based packets of information wherein the receipt of the packet may cause a buffer allocation or release. However, the principles of this invention may be applied to other types of packets, e.g. High Level Data Link Control (HDLC) and other devices, including non telephony devices. Furthermore, the principles of this invention may be applied to other devices and or applications having to allocate and release buffers.

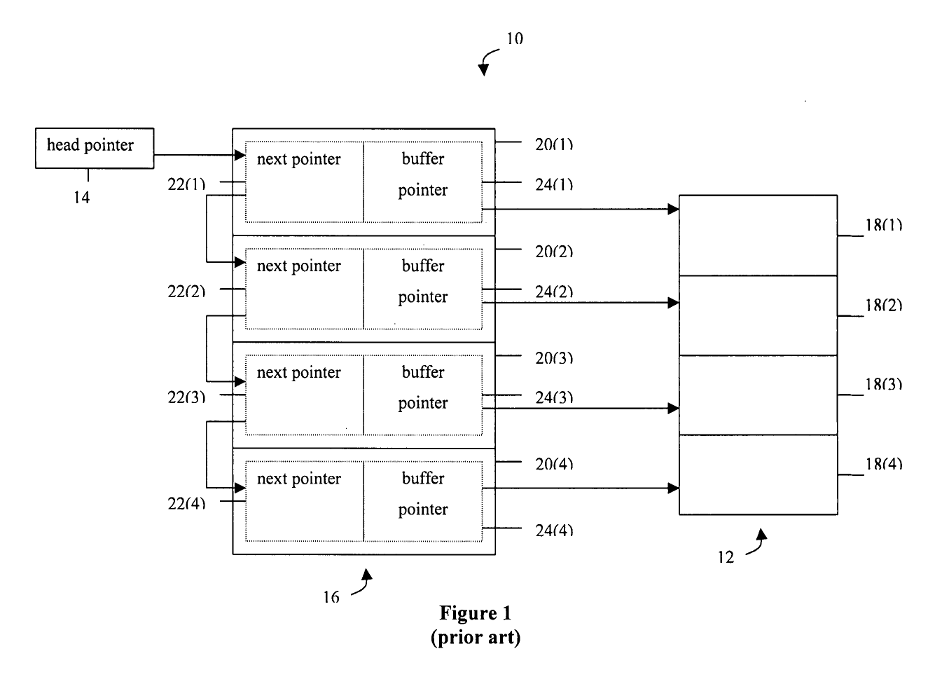

Referring to FIG. 1, an exemplary prior art schematic diagram of a link list buffer management 10 at application start up is provided. The link list buffer management 10 includes a buffer pool 12, a head pointer 14, and a link list table 16.

The buffer pool 12 is a repository of memory to be allocated by software, hardware or combinations thereof. The buffer pool 12 has an array of buffers 18 stored in memory. The buffer 18 may be free or occupied. “Free” refers to currently unallocated wherein “occupied” refers to currently allocated. A number of buffers is typically a power of 2, for example 65,536 buffers 18. However, it is common to reserve one of the buffers so that it is not allocated so that the index of the reserved buffer may be used for an end of list. As recognized by those skilled in the art, the end of list is typically a null, e.g. a zero. However, any suitable value such as “−1” may be used to indicate end of list.

The link list table 16 is a LIFO link list of references to the buffers 18 that are free. The link list table 16 includes a plurality of records 20 each having a next pointer 22 and a buffer pointer 24. The buffer pointer 24 references a buffer 18 in the buffer pool 12. The next pointer 24 may reference another next pointer having a reference to a buffer 18 that is free or to the end of list. The head pointer 14 provides an initial reference to the LIFO link list. The head pointer 14 references a first buffer that is free in the link table 24 via referencing a record 20 in the link list table 16. If however, there are no buffers 18 that are free the head pointer 14 references the end of list.

In the exemplary example of FIG. 1 all of the buffers 18 are free. The head pointer 14 references record 20(1). Record 20(1) references buffer 18(1) via the buffer pointer 24(1) and record 20(2) via the next pointer 22(1). Record 20(2) references buffer 18(2) via the buffer pointer 24(2) and the record 20(3) via the next pointer 22(3). Record 20(3) references buffer 18(3) via the buffer pointer 24(3) and the record 20(4) via the next pointer 22(3). Record 20(4) references buffer 18(4) via the buffer pointer 24(4) and the next pointer 22(4) references the end of list via the next pointer 22(n).

Allocating a buffer 18 causes a free buffer, if available, to be occupied. To allocate a buffer 18, the buffer 18 that is referenced from the record 20 that is pointed to by the head pointer 14 is allocated. The record 20 is removed from the LIFO list by changing the head pointer 14 to point to the next record in the LIFO list. For the illustrated example in FIG. 1, the head pointer 14 points to record 20(1). Since record 20(1) points to buffer 18(1) via buffer pointer 24(1), buffer 18(1) is used. The head pointer 14 is changed to the value in the next pointer 22(1) for record 20(1). The record 20(1) is effectively removed from the LIFO.

Releasing a buffer causes an occupied buffer to be free. When a buffer 18 is released, a record 20 is changed to point to the released buffer via the buffer pointer 24. The next pointer 22 in the record 20 is changed be the value in the head pointer. The head pointer is subsequently changed to point to the record.

A problem with this solution is the large amount of memory it uses. For example, if there are 65,536 buffers then the pointer should be least a 16 bits, which is two bytes. Since each record 20 in the link list table 16 has two pointers, the record size for this example is at least 4 bytes. The size of the link list table 16 would need to at least be 262,144 bytes (256 K bytes). Another problem is that allocation and a release requires many operations, e.g. read, or write, which increases processing overhead. Yet another problem is that the memory for the link list table 16 is located off of the controller chip, increasing the number of pins and the overall system cost. Additionally, in a redundant system, this solution is difficult to keep synchronized.

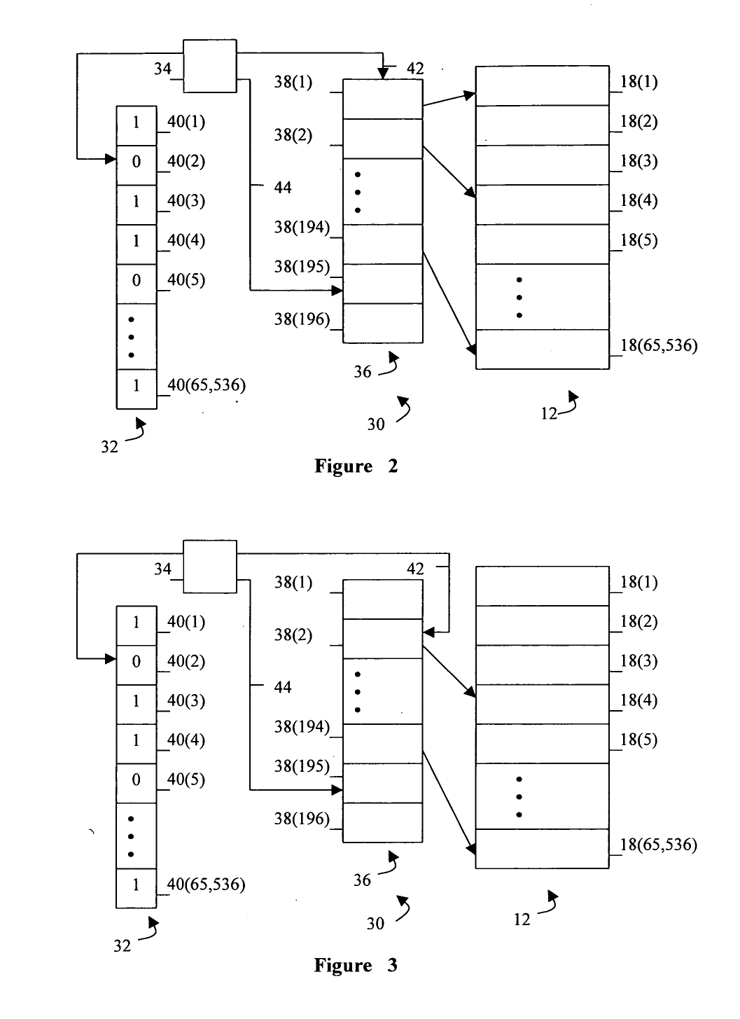

Now referring to FIG. 2 an exemplary schematic diagram of an improved buffer management 30 in accordance with the present invention is provided. The improved buffer management includes a bit vector 32, a scanner 34, a cache 36, and a buffer pool 12. The scanner 34 is coupled to the bit vector 32 and the cache 36. The term “coupled” refers to any direct or indirect communication between two or more elements in the buffer management, whether or not those elements are in physical contact with one another.

The buffer pool 12 is a repository of memory to be allocated by software, hardware or combinations thereof. The buffer pool 12 has a plurality of buffers 18 stored in memory, wherein a number of buffers is typically based on a power of 2. In a preferred embodiment the buffers are an array of fixed size buffers. In another embodiment, the buffer pool 12 is divided into sections where each section has a different buffer size. For example, the buffer pool 12 may be divided so that buffers 18(1)-18(32,767) have a buffer size of 64 bytes, buffers 18(32,768)-18(49,151) may have a buffer size of 128 bytes, and buffers 18(49,152)-18(65,536) may have a buffer size of 20 bytes. In another embodiment, the size of the buffer 18 in the buffer pool 12 is based on a modulus of the index. For example, using a modulus of 10, indexes that end in 0, 1, 2, and 5 may reference a buffer size of 64 bytes, and indexes of 3, 4, 6, 7, 8, and 9 may reference a buffer size of 32 bytes. For this example the number of buffers is 65,536, which is 64 K. The buffer 18 may be free or busy. “Busy” refers to occupied and a transitional state. The transitional state described in further detail below.

The bit vector 32 has a representation of which buffers 18 are free and which buffers 18 are busy, wherein each buffer 18 has a corresponding bit 40 in the bit vector 32 and each bit 40 indicates if the buffer 18 is free or busy. In the exemplary illustration, “1” represents busy and “0” represents free. However, it would be understood by those skilled in the art that “1” may represent free and “0” may represent busy. The size of the bit vector 32 is the number of buffers divided by the number of bits in a byte. For the illustrated example, the size of the bit vector 32 is 65,536/8, which is 8 K bytes.

The cache 36 is a storage mechanism, preferable a high-speed storage hardware mechanism, that stores a reduced number of pointers to buffers 18 that are free. However, the cache 36 may be implemented using a combination of hardware and software. Reduced meaning fewer than the number of buffers 18. This is in contrast to a one to one relationship in FIG. 1. In the illustrated example, the cache has 196 pointers. The cache 36 is preferably a FIFO list. As would be known by those skilled in the art, a FIFO list requires a read pointer 42 and a write pointer 44.

The scanner 34 scans the bit vector 32 for buffers 18 that are free as described in further detail below.

Still referring to FIG. 2, the illustrated example shows a bit 40(1) corresponds to buffer 18(1) and indicates that the buffer 18(1) is busy. A bit 40(2) corresponds to a buffer 18(2) and indicates that the buffer 18(2) is free. The mapping of the bits 40 to the buffers 18 continues in the process for each bit in the bit vector 32.

A pointer 38(1) points to a buffer 18(1) that is busy, a pointer 38(2) points to a buffer 18(4) that is busy, and a pointer 38(194) points to a buffer 18(65,536) that is busy. Although a bit 40(3) indicates that a buffer 18(3) is busy it is not in the cache 36 and is therefore occupied. The buffers 18 that have pointers 38(1), 38(4), 38(65,536) in the cache 36 are in the transitional state, that is, buffers 18(1), 18(4), 18(65,536) are not occupied but are marked busy in the bit vector 32 and are in the cache 36.

It would be understood by those skilled in the art, the read pointer 42 points to a pointer 38 in the cache 36 to be used when allocating a buffer 18 whereas the write pointer 44 points to a pointer 38 in the cache 36 to be used when releasing a buffer 18. As would also be understood by those skilled in the art, when the read pointer and the write pointer are the same, none of the pointers 38 in the cache 36 are referencing a buffer 18. For the illustrated example of FIG. 2, the read pointer 42 points to the cache pointer 38(1) and the write pointer 44 points to the cache pointer 38(195).

Now referring to FIG. 3, another exemplary schematic diagram of an improved buffer management 30 in accordance with the present invention is provided. FIG. 3 illustrates the improved buffer management 30 after an allocation of a buffer 18 in contrast to a before allocation of the buffer 18 illustrated by FIG. 2.

The read pointer 42 is used to determine the buffer 18 to allocate. When the buffer 18 is allocated, the read pointer 42 is updated to point to a next pointer 38 in cache 36. If however, the read pointer 42 reaches a last pointer 38 in the cache 36, the read pointer 42 is set to a first pointer in the cache 36. Also, the buffer 18 that is pointed to by the pointer 38 referenced by the read pointer 42 becomes occupied. The bit vector 32, however, is advantageously not changed by the allocation since changing the bit vector 32 would require extra processing. Although, those skilled in the art would recognize that the bit vector 32 may be changed. The allocation causes changes to the buffer 18, the cache 36, and a read pointer 42 that are a processing overhead for the allocation. The processing overhead for the allocation advantageously may have less processing overhead, e.g. time to process, than by the link list of FIG. 1.

Referring to FIG. 2, read pointer 42 points to the pointer 38(1) in cache 36. In contrast, FIG. 3 illustrates the read pointer 42 points to the pointer 38(2) in cache 36 and that the buffer 18(1) is occupied.

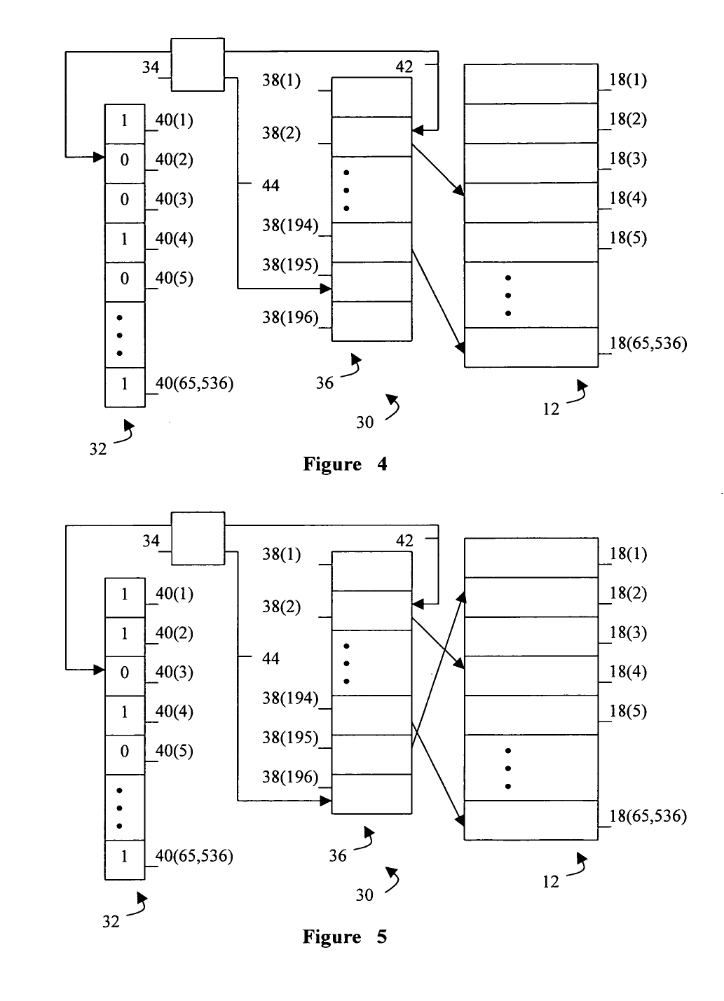

Now referring to FIG. 4, another exemplary schematic diagram of an improved buffer management 30 in accordance with the present invention is provided. FIG. 4 illustrates the improved buffer management 30 after a release of a buffer 18 in contrast to a before releasing the buffer 18 illustrated by FIG. 3. When a buffer is released the bit vector 32 is modified to represent the release. A release of the buffer 18 has the processing overhead of a change to the bit vector 32. A release of the buffer 18 typically has less processing overhead than the processing by the link list of FIG. 1.

Referring to FIG. 3, the bit 40(3) indicates that buffer 40(3) is busy. In contrast, FIG. 4 shows that bit 40(3) indicates that the released buffer 40(3) is free.

Now referring to FIG. 5, another exemplary schematic diagram of an improved buffer management 30 in accordance with the present invention is provided. The contrast of FIGS. 4 and 5 illustrates how the scanner 34 may change the bit vector 32 and the buffer cache 36.

The scanner 34 scans the bit vector 32 to find buffers 18 that are free. If the scanner 34 finds a buffer 18 that is free and the cache 36 has an unused pointer, the scanner changes the bit vector 32 to indicate the buffer 18 is busy and changes the cache 36 to point to the buffer 18. The buffer 18 in this case has not been allocated so it is not occupied, nor is the buffer 18 free; hence, buffer 18 is in a transitional state. The pointer is the index in the bit vector 32 that the buffer 18 that was free was found. Those skilled in the art would recognize that the pointer might be calculated differently particularly if the pointer was in a different format, e.g. an address.

Referring to FIG. 4, bit 40(2) indicates the buffer 18(2) is free, and that write pointer 38 points to pointer 38(195) in the cache. In contrast, FIG. 5 illustrates that bit 40(2) is busy, pointer 38(195) points to buffer 18(2), and write pointer 44 points to pointer 38(196) in the cache 36.

In one embodiment, the scanner 34 starts at the first bit 40(1) and linearly searches the bit vector 32 for a buffer 18 that is free. After finding a buffer 18 that is free the scanner 34 continues scanning starting with the next bit in the bit vector 32. After reaching the last bit, illustrated ad 40(65,536), the scanner starts at the top of the bit vector 32 with the first bit 40(1). It would be recognized by those skilled in the art that other scanning techniques might be used. For example, the scan may start at the bottom of the bit vector 32 with bit 40(65,546) or after finding a buffer 18 that is free the scan may restart at the top or bottom of the bit vector 32.

A scan rate is time it take for the scanner to scan the bit vector 32. The scan rate is based on the size of the bit vector, the rate of the memory access, and the size of the bus using a memory. Increasing the bus size decreases the scan rate. Likewise, increasing the memory access decreases the scan rate.
scan rate=(size of the bit vector/size of the bus)/rate of the memory access
For this example, an access of 156 Mhz and a 4-byte-wide data bus would take (8 K/4)/156, which is 13.1μ seconds, to scan the bit vector 32.

A number of pointers in the cache 36 should be large enough to avoid starvation. Starvation occurs when none of the pointers 38 in cache are referencing a buffer 18 and the buffer pool 12 has buffers that are free. The number of pointers in the cache is based on how quickly processing must achieved. For example, the receipt of an Ethernet packet may result in a buffer allocation. The number of pointers may then be based on a packet transfer rate, a minimum packet size, and a minimum gap size between the packets. Assuming a 10 Gigabits per second (Gbps) packet transfer rate, a minimum packets size of 64 bytes, and a minimum gap size between packets of 20 bytes a processing rate bits may be determined.
Packet transfer rate [bits]/((packet size+gap size)*8)

The above formula has the packet transfer rate in bits. Since the packet size and the gap size are in bytes, the sum of the sizes is multiplied by 8 to convert to a bit size. For this example 10,000,000,000/((64+20)*8)=˜15 Mega-packets per second. This may then be converted to 66.6 ns per packet. It follows that the number of pointers 38 should be at least 13.1μ seconds/66 ns=13,100/66.6=196 packets.

With 196 pointers 38, each pointer having a size of 2 bytes, the cache 36 would include a size of 392 bytes. The 392 bytes of memory used by the cache 36 plus the 8 K bytes of memory used by the bit vector 32 is significantly less than 256 K bytes of memory used by the prior art illustrated by FIG. 1.

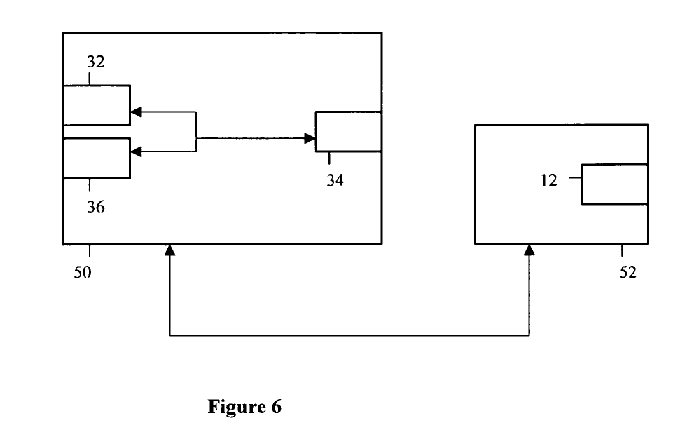

Now referring to FIG. 6, an exemplary schematic diagram of a hardware solution for managing buffers in accordance to the present invention is provided. The management of the buffers may be in software, hardware or a combination thereof. However, it is preferable that the management is handled via a hardware device, such as illustrated in FIG. 6.

FIG. 6 illustrates a device 50 coupled to a memory unit 52. The device 50 may be any suitable device having circuitry able for managing buffers, such as an Application Specific Integrated Circuit (ASIC), Field Programmable Gate Array (FPGA), and the like. The exemplary illustrated device 50 includes the scanner 34, the bit vector 32, and the cache 36.

The memory unit 52 is a hardware unit, such as a Random Access Memory (RAM), or a magnetic disk, that is capable of storing and retrieving information. The memory device includes buffer pool 12.

Using the device 50 may advantageously reduce the number of chip pins in a system using the methods of the present invention. Furthermore, using the device 50 may be advantageous by offloading processing normally handled via a software process, such as an application.

It would be recognized by those skilled in the art that there may be other embodiments of the device 50. For example, the bit vector 32 may be located in the memory unit 52

While the invention has been described in terms of a certain preferred embodiment and suggested possible modifications thereto, other embodiments and modifications apparent to those of ordinary skill in the art are also within the scope of this invention without departure from the spirit and scope of this invention. Thus, the scope of the invention should be determined based upon the appended claims and their legal equivalents, rather than the specific embodiments described above.

1. A method for managing buffers in a telephony device, comprising:
providing a plurality of buffers stored in a memory;
providing a cache having a pointer pointing to the buffer;
scanning the cache to determine if the cache is full; and
when the scan determines the cache is not full
determining a free buffer from the plurality of buffers,
generating a pointer for the free buffer, and
placing the generated pointer into the cache.

2. The method according to claim 1, wherein a number of pointers in the cache is fewer than a number of buffers in the plurality of buffers.

3. The method according to claim 1, further comprising providing a data table indicating a disposition of free or busy for of each of the plurality of buffers.

4. The method according to claim 3, wherein the data table is a bit vector.

5. The method according to claim 3, further comprising when a buffer is unallocated, changing the data table to indicate the unallocated buffer is free.

6. The method according to claim 3, wherein when the scan determines the cache is not full further comprising setting the data table to indicate that the buffer is busy.

7. The method according to claim 1, further comprising:
when allocating a buffer in the plurality of buffers,
determining if the cache is empty,
if the cache is not empty
changing the cache to remove a pointer to the allocated buffer.

8. A device for managing memory, comprising;
a data table stored in a first memory, the data table having a used or a busy disposition of a buffer pool in a second memory, the buffer pool having a plurality of buffers;
a cache stored in a third memory, the cache having a plurality of pointers that points to a portion of the plurality of buffer with the free disposition, a number of pointers in the cache is fewer than a number of buffers in the plurality of buffers; and
a scanner that scans the cache after a period of time.

9. The device according to claim 8, wherein the first data table is a bit vector.

10. The device according to claim 8, wherein when a buffer in the plurality of buffers is allocated, the cache is changed to remove a pointer pointing to the buffer.

11. The device according to claim 10, wherein when the buffer in the plurality of buffers is released, the data table is changed to indicate a free disposition

12. The device according to claim 8, wherein the scanner detects a buffer in the plurality of buffers having free disposition in the data table.

13. The device according to claim 12, wherein the scanner determines the cache is not full.

14. The device according to claim 13, wherein the scanner sets the disposition in the data table for the buffer in the plurality of buffers to busy, the scanner determines a pointer for the buffer in the plurality of buffers, and the pointer is added to the cache.

15. The device to claim 8, wherein the device is an Application Specific Integrated Circuit (ASIC), or Field Programmable Gate Array (FPGA).

16. A device for managing memory, comprising;
a bit vector having a used or a busy disposition of a buffer in a buffer pool, the bit vector stored in a first memory and the buffer pool having a plurality of buffers stored in a second memory
a cache having a plurality of pointers pointing to a portion of the plurality of buffer with the free disposition, the cache having fewer pointers than buffers in the plurality of buffers; and
a scanner that scans the cache and sets the disposition in the bit vector for a buffer in the plurality of buffers to busy, and adds to the cache a pointer pointing to the buffer.

17. The device according to claim 16, wherein the buffer is allocated and the cache is changed to remove the pointer pointing to the buffer.

18. The device according to claim 17, wherein when the buffer is released and the data table is changed to indicate a free disposition

19. The device to claim 16, wherein the device is an Application Specific Integrated Circuit (ASIC), or Field Programmable Gate Array (FPGA).
